(19) United States
(12) Patent Application Publication
(10) Pub. No.: US 2012/0182288 A1
(43) Pub. Date: Jul. 19, 2012

(54) METHOD AND APPARATUS FOR INFORMATION PRESENTATION

(75) Inventors: Stephen Douglas Williams, San Jose, CA (US); Kevin Arthur Campbell, Fremont, CA (US)

(73) Assignee: Sony Corporation

(21) Appl. No.: 13/008,204

(22) Filed: Jan. 18, 2011

(51) Int. Cl. G06T 15/00; G09G 5/00

(52) U.S. Cl. 345/419; 345/636

(57) ABSTRACT

Methods and apparatus are provided for presenting information associated with display of text. In one embodiment a method includes displaying a graphical representation of at least one of text and diagram data on a display, displaying a graphical element, by the device, to provide an indication of information associated with the graphical representation, and detecting a triggering input during display of the graphical representation, wherein the triggering input is based on displacement of the device. The method may further include updating the display to present information associated with the graphical representation of the at least one of text and diagram data. Methods and devices may also be provided to allow for display of diagram data and information in a layered format, wherein information may be displayed separately or in addition to a graphical display.

### FIELD

The present disclosure relates generally to electronic devices, and more particularly to methods and apparatus for presenting information associated with display of text and/or diagram data.

### BACKGROUND

Typical electronic reading devices (e.g., eReaders) allow for users to view text. The displayed text is usually associated with a read-only file. Some devices additionally allow users to mark portions of displayed text, such as an electronic bookmark. However, the text presented to the user by these conventional devices is generally in a fixed display format. As such, the user cannot access information pertaining to the text or displayed material via the device. Similarly, information cannot be presented for specific portions of text that is not part of the text display. For many electronic files, data other than the digital text is not included during display as the elements would typically occupy a large portion of the display panel. In some cases, display of additional information will reduce the display size of text. Thus, there is a desire for a solution that allows for easy access to additional data and presentation of the data on a device. In addition, there exists a need to allow for users to access information related to displayed text.

### BRIEF SUMMARY OF THE EMBODIMENTS

Disclosed and claimed herein are methods and apparatus for presenting information associated with display of at least one of text and diagram data. In one embodiment, a method includes displaying, by a device, a graphical representation of at least one of text and diagram data on a display, displaying a graphical element, by the device, to provide an indication of information associated with the graphical representation, and detecting a triggering input, by the device, during display of the graphical representation, wherein the triggering input is based on displacement of the device. The method further includes updating the display, by the device, to present information associated with the graphical representation of the at least one of text and diagram data.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a device according to one or more embodiments;

FIG. 2 depicts a process for presenting information associated with display of text according to one or more embodiments;

FIG. 3 depicts a simplified block diagram of a device according to one embodiment;

FIG. 4 depicts a graphical representation of a process for presenting information associated with display of text according to one or more embodiments;

FIG. 5 a graphical representation of a process for presenting information associated with display of text according to one or more embodiments;

FIGS. 6A-6B depict graphical representations of processes for presenting information according to one or more additional embodiments; and

FIG. 7 depicts a graphical representation of a process for presenting information according to another embodiment.

### DETAILED DESCRIPTION OF THE EXEMPLARY EMBODIMENTS

### Overview and Terminology

One embodiment relates to presenting information by a device, such as an electronic reader (e.g., eReader) device, or a device executing an electronic reader application. For example, one embodiment is directed to a process for presenting information associated with text of an electronic book (e.g., eBook) and/or digital publication. The process may include displaying a graphical representation of text and detecting a triggering input. Based on the triggering input the device may be configured to update the display to gradually present information to the user. In that fashion, a user operating a device may advantageously view information in addition to text of an electronic book. Further, the presentation of the information may be advantageously revealed at the users discretion. In contrast to conventional methods for displaying electronic text, such as eReader and browser devices, the methods and devices described herein allow for improved access and viewing of information associated with the digital text presentation.

According to another embodiment, information may be presented for diagram data in addition to, or separately from, the display of text. By way of example, the methods and devices described herein may be configured to display graphical representations of diagram data related to one or more of mapping diagrams, three-dimensional diagrams, and layered diagrams, etc. In yet another embodiment, information presented by the device may not be limited to text or visually displayed information. In certain embodiments, information presented by the device may include one or more of audio, tactile (e.g., based on a vibration motor in the device), and data for driving an external device (e.g., external display, TV, etc.).

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

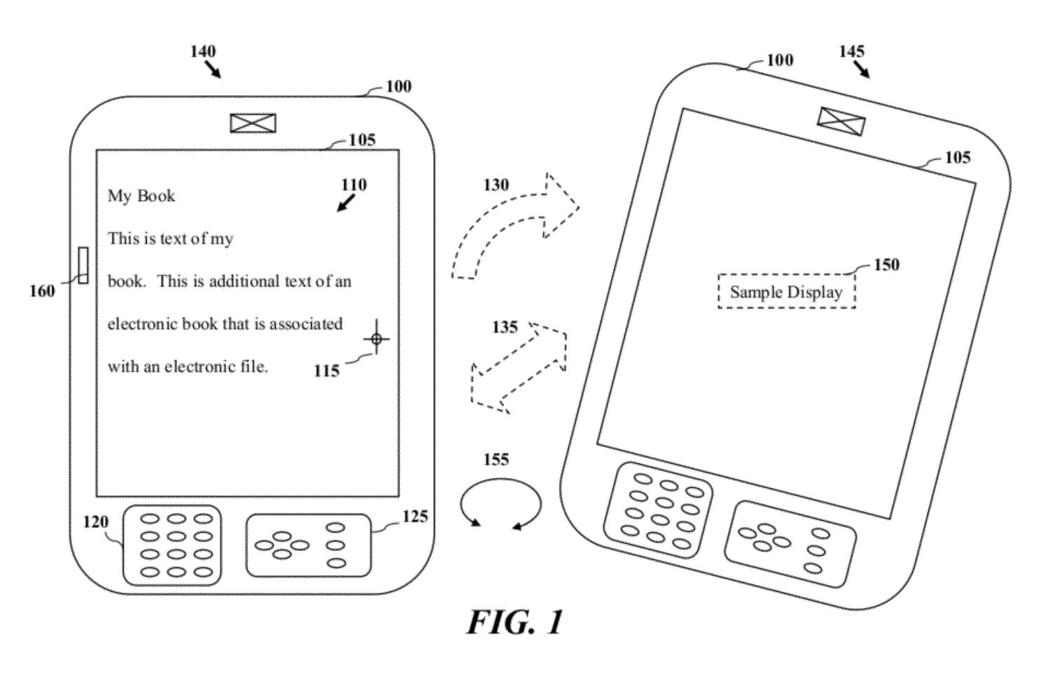

Referring now to the figures, FIG. 1 depicts a graphical representation of a device according to one or more embodiments. In particular, FIG. 1 depicts a presentation of information associated with the display of text by device 100. In one embodiment, device 100 may relate to an eReader device configured to display graphical representations of text associated with one or more of eBooks, electronic publications, and digital text in general. As user herein, “text” may include data related to written text and may further include image data. According to another embodiment, device 100 may relate to an electronic device (e.g., computing device, personal communication device, media player, etc.) configured to execute an eReader application or browser application in general.

As depicted in FIG. 1, device 100 includes display 105. Display 105 is configured to display a graphical representation of text 110. The text may be associated with an electronic book (e.g., eBook) file or text file in general. Device 100 may further be configured to display graphical element depicted as 115. Graphical element 115 may be displayed to provide an indication of information associated with graphical representation of text 110. Although depicted as a symbol in FIG. 1, it should also be appreciated that graphical element 115 may alternatively, or in combination, be displayed as one or more of text and formatting applied to text by device 100. Device 100 is further depicted to include one or more input devices, such as buttons 120 and 125. Buttons 120 and 125 may be employed to control display of text associated with eReader operation and/or browser operation.

Device 100 may be configured to present information associated with displayed text. Based on a triggering input, device 100 may be configured to present information associated with displayed text. Information, for example, may relate to additional text, a formula, a translation of text, include image data and/or video data. In certain embodiments, information may relate to a position, such as an indication of a chapter, page, or section, of an electronic text file. It may be desirable to display information for a variety of reasons. In the educational context, it may be advantageous to allow a user to access particular information after reading a portion of text. Similarly, it may be desirable to provide reference information on demand, wherein the device displays a graphical representation of text and allows the user to access additional information when desired. The methods and devices described herein additionally allow for presentation of information when a display does not include space for additional information, or scale of the information is different from text.

According to one embodiment, a triggering input may be detected by device 100 based on user applied motion. FIG. 1 depicts arrows 130 and 135, wherein each arrow represents displacement of device 100 for a triggering input. For example, the triggering input may displace device 100 from position 140 to position 145. The triggering input may be based on rotation, as depicted by 130, displacement depicted by 135, and/or three-dimensional displacement. Based on the triggering input, device 100 may display information depicted as 150. As shown in FIG. 1, information 150 is depicted as text, however, it should be appreciated that presentation of information is not limited to text. Similarly, display of information 150 is oriented relative to the initial position (e.g., position 140) of device 100 prior to triggering input. However, it should be appreciated that device 100 may present information 100 relative to one or more arrangements as depicted by direction arrow 155. According to another embodiment, a triggering input may require that user press a button of device 100 before the triggering input can be detected. Button 160 relates to a dedicated button that may be activated by the user prior to initiating the triggering input. In certain embodiments, graphical elements, such as graphical element 115, may be displayed following user activation of button 160. It should also be appreciated that the triggering input may be detected in conjunction with one or more other inputs of device 100, such as activation of inputs 120, inputs 125, or user touch of display 105 when the display is configured for touch screen operation.

In certain embodiments, device 100 may be configured to display information related to mapping files. For example, the triggering input may prompt display or one or more additional layers to allow for a progressive display. In mapping and text applications, display elements may be transitioned to half-tone versions of display elements to allow for display of multiple layers.

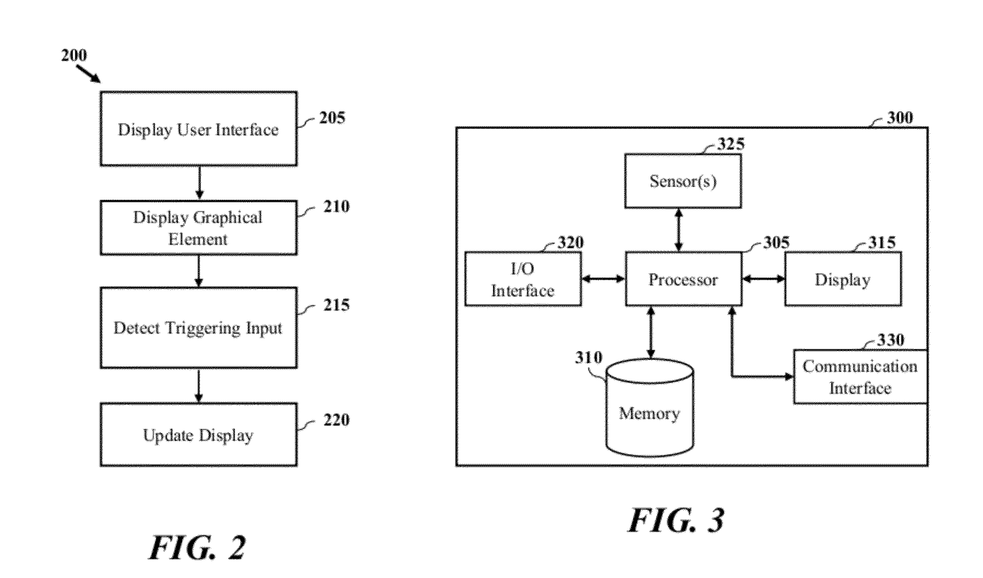

Referring now to FIG. 2, a process is depicted for presenting information associated with display of text according to one or more embodiments. Process 200 may be employed by the device of FIG. 1, eReader devices and devices configured to provide eReader applications, such as computing devices, personal communication devices, media players, gaming systems, etc.

Process 200 may be initiated by displaying a user interface at block 205. The user interface may include a graphical representation of text on a display (e.g., display 105). The graphical representation of text may relate to display of text by an electronic reader application and/or a browser (e.g., network browser, text browser, graphical browser, etc.). At block 210, the device may display a graphical element to provide an indication of information associated with the graphical representation of text. The graphical element may relate to one or more of a symbol, text, and formatting applied to displayed text, such as the graphical representation of text, in the display. When multiple information elements are available, the device may display multiple graphical elements to indicate the information elements available. The information may include one or more of text, a formula, translated text, and a reference position to a portion of the electronic text file (e.g., page, chapter, section of an eBook, etc.). In certain embodiments, display of graphical elements may first require user activation of a button (e.g., button 160) prior to display of the graphical elements.

Process 200 may proceed to detect a triggering input at block 215. The triggering input may relate displacement, or a particular movement, of the device to indicate a users desire to view information associated with the graphical representation of text. As used herein, displacement may relate to any combination of physical motion and a motion sequence, such as a gesture. In certain embodiments, the displacement may relate to a gesture based movement, or flick of the device, in a semicircular motion. The movement may further be based on and/or employ angular displacements. Movements in certain planes may be detected to allow a user to different display or presentation of information for separate layers. For example, in one embodiment lateral displacement may adjust a lower level, while vertical tilt may adjust an upper layer. It should also be appreciated that gesture based movements may include shaking or patterns of shakes to detect a triggering input. Similarly, gesture based movements may include waving (e.g., an arcing movement), wiping (e.g., a sliding movement in a fixed orientation from side to side), pulsing (e.g., quick tilting back and forth) three-dimensional movement.

Based on the triggering input, the device may update the display at block 220. The display may be updated into include presentation of information. One advantage of presenting the information based on the triggering input may be the ease of access. For example, the device may be configured to detect the triggering input without requiring the user to navigate to a particular section of the display. Further, process 200 may employ one or more additional presentations of information based on additional triggering inputs or gestures as described herein.

Although the description of process 200 has been described with reference to eBook or eReader files, it should also be appreciated that the methods and devices described herein are not limited to eBook files or applications. For example, the devices and methods described herein may be employed for viewing data associated with presentation files or presentation programs. Similarly, viewing data associated with map files, or layers may be presented in a similar manner to presentation to the described presentation of information with text.

Referring now to FIG. 3, a simplified block diagram is depicted of a device according to one embodiment. Device 300 may relate to an eReader device configured to display graphical representations of text associated with one or more of eBooks, electronic publications, and digital text in general. In one embodiment, device 300 relates to the device of FIG. 1. As depicted in FIG. 3, device 300 includes processor 305, memory 310, display 315, input/output (I/O) interface 320, one or more sensors, depicted as sensor(s) 325, and communication interface 330. Processor 305 may be configured to control operation of device 300 based on one or more computer executable instructions stored in memory 310. In one embodiment, processor 305 may be configured to execute an eReader application. Memory 310 may relate to one of RAM and ROM memories and may be configured to store one or more files, and computer executable instructions for operation of device 300. Although depicted as a single memory unit, memory 330 may relate to one or more of internal device memory and removable memory.

Display 315 may be employed to display text, image and/or video data, and display one or more applications executed by processor 305. In certain embodiments, display 315 may relate to a touch screen display. I/O interface 320 may be employed to control operation of device 300 including controlling playback of an eBook and/or digital publication. Inputs I/O interface 320 may include one or more buttons for user input, such as a such as a numerical keypad, volume control, menu controls, pointing device, track ball, mode selection buttons, and playback functionality (e.g., play, stop, pause, forward, reverse, slow motion, etc). Buttons of I/O interface 320 may include hard and soft buttons, wherein functionality of the soft buttons may be based on one or more applications running on device 300.

Device 300 may include one or more sensors configured to detect displacement or movement of the device. Sensor(s) 325 may relate to one or more single or multi-axis sensors configured to detect displacement in one or more dimensions. In certain embodiments, sensor(s) 325 may relate to a sensor configured to detect a triggering input based on displacement and or rotation of the device in one or more dimensions. Sensor(s) 325 may relate to three-axis sensors, such as three-axis magnetometers and three-axis accelerometers.

Communication interface 330 may be configured to allow for receiving and/or transmitting data including text files, eBooks, and information associated with relative to one or more devices via wired or wireless communication (e.g., Bluetooth™, infrared, etc.). Communication interface 330 may be configured to allow for one or more devices to communicate with device 300 via wired or wireless communication. Communication interface 330 may include one or more ports for receiving data, including ports for removable memory. Communication interface 330 may be configured to allow for network based communications including but not limited to LAN, WAN, Wi-Fi, etc. In one embodiment, communication interface 330 may be configured to access an electronic text stored by a server.

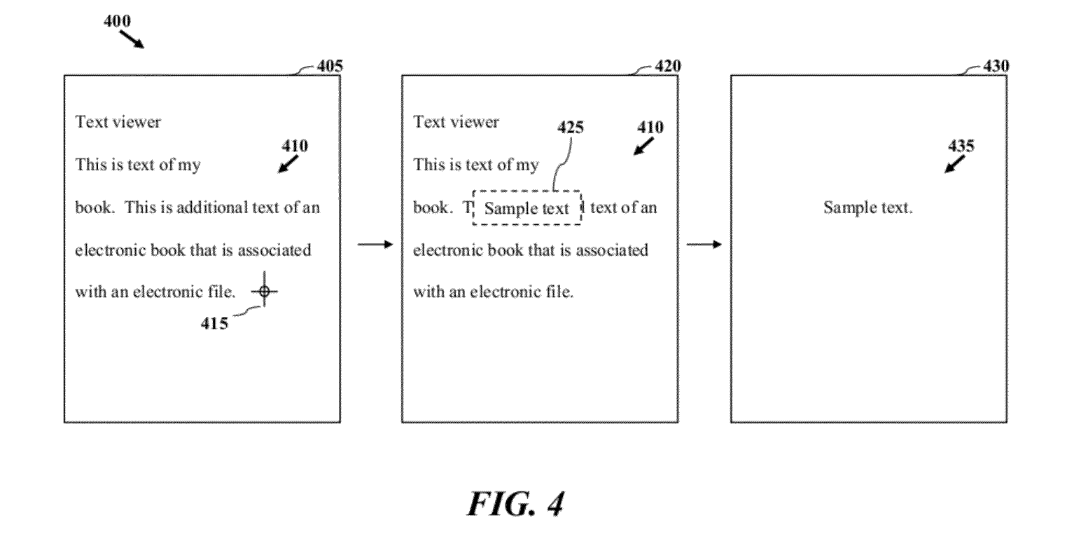

Referring now FIG. 4, a graphical representation of a process is depicted for presenting information associated with display of text according to one or more embodiments. Process 400 may be employed by an eReader device, or device (e.g., device 100) configured to execute an eReader application. Process 400 is depicts display outputs or windows, which may be employed as a user interface, of a device. Display window 405 includes display of a graphical representation of text 410. Text 410 may relate to a portion of an electronic file. Display 405 further includes graphical element 415 depicted as a symbol that may be employed to identify information associated with displayed text 415.

Based on detection of a triggering input, the device may update the display as depicted by process 400. For example, following a triggering input, the device may update the display from 405 to display window 420, wherein the device continues to display the graphical representation of text 410 with the addition of information depicted as 425. The device may continue to update the display such that information 435 is provided by display window 430. In that fashion text 410 may be replaced, at least temporarily, by the display of information 435. The transition of process 400 may be a smooth transition wherein the display elements are faded from display window 405 to display window 430. Following display of information in display window 430, the device may be configured to return to the graphical representation of text in display window 405.

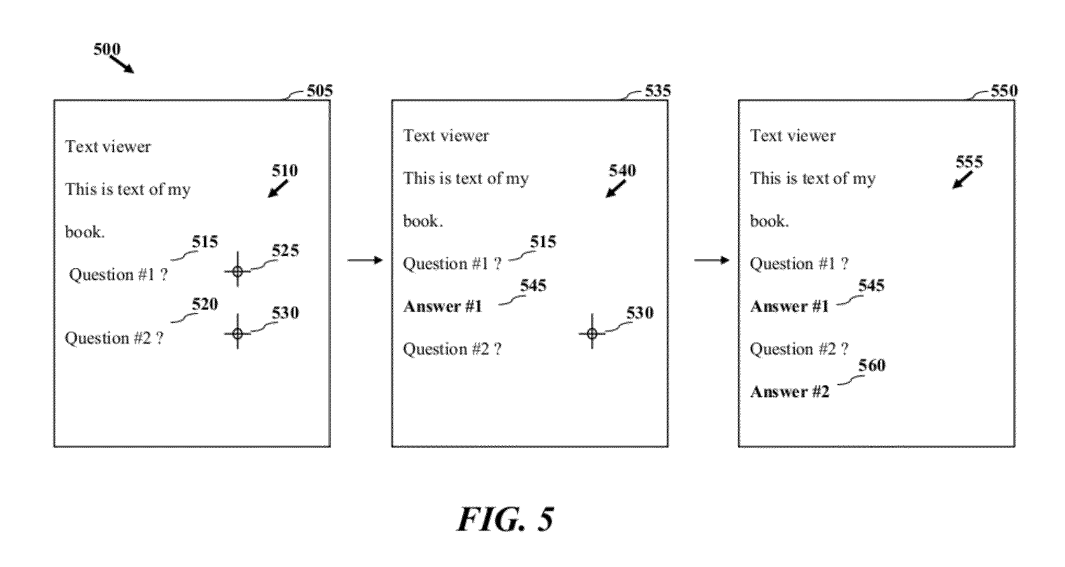

Referring now to FIG. 5, a graphical representation of a process is depicted for presenting information according to another embodiment. Process 500 may be employed by an eReader device, or device (e.g., device 100) configured to execute an eReader application. Process 500 may provide an initial display of text and may reveal information based on a user or triggering input. In that fashion, information may be presented for educational purposes or other uses. Process 500 is depicted as a simplified series of display outputs or windows that may be employed as a user interface for a device. Display window 505 includes display of a graphical representation of text as depicted by 510 including questions 515 and 520. The display additionally may include graphical elements 525 and 530 associated with questions 515 and 520 respectively. Based on detection of a triggering input, the device may update the display to reveal information as depicted in display window 535. Display window 535 includes an updated graphical representation 540 including answer 545 to question 515. Based on a second or further triggering input, the device may be configured to update the user interface to display window 550 which includes graphical representation of text 555 and answer 560. Need to add 530 and 555. Accordingly, in that fashion the device may be configured to reveal a plurality of information elements. As depicted in FIG. 5, graphical elements may be displayed until information associated with the graphical elements is presented.

As depicted in FIG. 5, question and answer elements may be employed for educational purposes. As such information may take the form of one or more of mathematical equations, chemical formulas, computer programs, science relationships and values, etc. It also should be appreciated that information of answers 545 and 565 may relate to multiple display elements wherein each element may be displayed based at incremental rates following a triggering event. For example, when answer 565 relates to the solution to a problem, elements of the information may be provided as individual steps showing steps necessary to solve the problem. Reveals may be controlled in a group setting in some embodiments. For example, devices may be configured to receive signals from one or more other devices via a network connection (e.g., internet) to control the presentation of information. Group controlled reveals may be advantageous in an education or presentation setting.

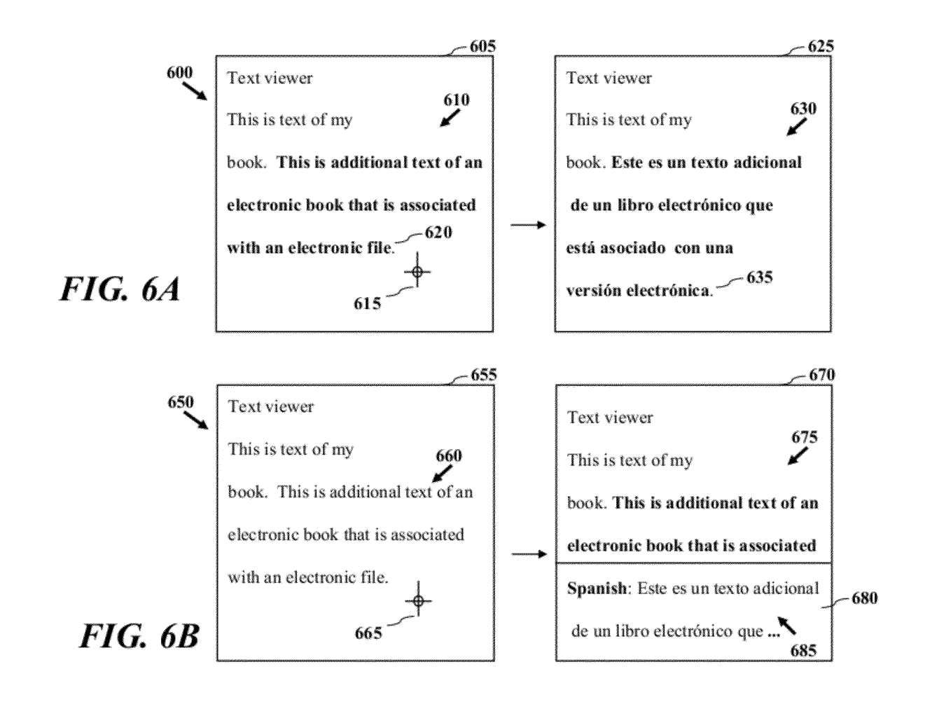

Referring now to FIGS. 6A-6B, graphical representations of processes are depicted for presenting information according to one or more additional embodiments. In particular, FIGS. 6A-6B relate to presenting information for translations of displayed text. In the embodiment described in FIG. 6A, a displayed graphical representation of text may be replaced with a transition of the text based on a triggering input. As will be discussed in FIG. 6B, a translation of a graphical representation of text may be displayed in addition to the graphical representation of the text. Processes 600 and 650 may be employed by an eReader device, or device (e.g., device 100) configured to execute an eReader application to allow for an initial display of text, and reveal information based on a user or triggering input.

In FIG. 6A, process 600 may be initiated by display of window 605 to include a graphical representation of text 610. Display window 605 further includes graphical element 615 (e.g., graphical element 115). Display window 605 further includes display of a portion of the graphical representation of text 610 formatted as bold. In certain embodiments, formatted text labeled 620 (e.g., the bolded text) may be employed as a graphical element to provide an indication of available information. Based on detection of a triggering event by the device, the device may update the user interface display to display window 625 including graphical representation of text 630. Graphical representation of text 630 includes a translated portion of text, shown as 635, associated with formatted text 620. In that fashion, information may be presented based on a triggering input to provide a translation.

FIG. 6B depicts a graphical representation of process 650 which may be initiated by display of window 655 to include graphical representation of text 660. Display window further includes graphical element 665 (e.g., graphical element 115) and display of a portion of the graphical representation of text that may be translated. Based on detection of a triggering event by the device, the device may update display window 655 to display window 670 including graphical representation of text 675 and window 680 including a translation of text depicted as 685. The translated portion of text 685 may be associated with a bolded portion of text 675. In that fashion, information may be presented based on a triggering input while continuing to present the graphical representation of text. Although, processes depicted in FIGS. 6A-6B relate to display of translations of text to another language, it should be appreciated that display characteristics may be applied to other embodiments described herein.

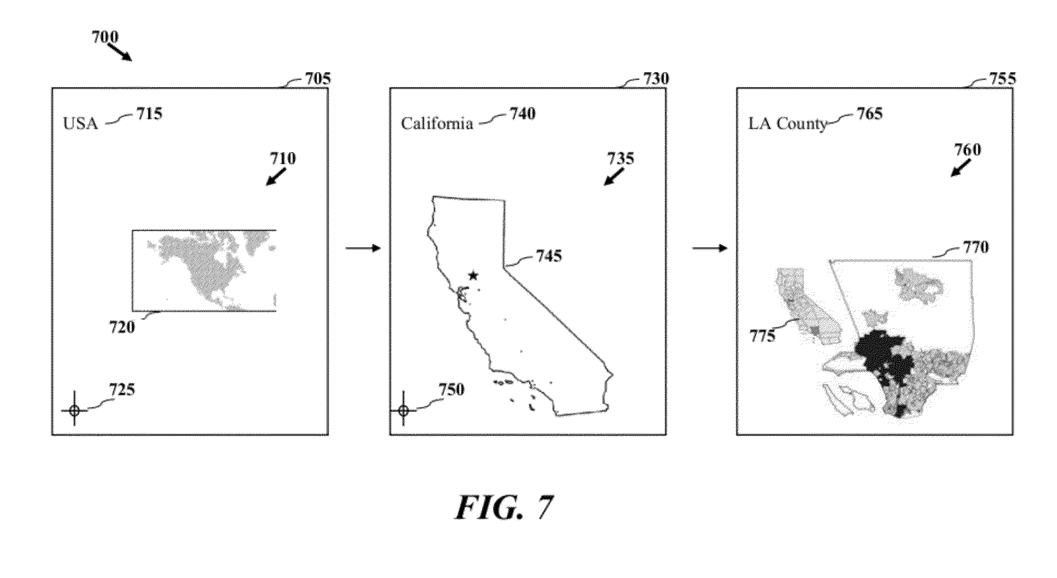

Referring now to FIG. 7, a graphical representation of a process is depicted for presenting information according to another embodiment. Process 700 may be employed by a device (e.g., device 100) to present information associated with display of at least one of text and diagram data. In particular, FIG. 7 depicts diagram data including mapping data in addition to text. Process 700 may provide an initial display window 705 including graphical representation 710 of text 715 and map diagram 720. Display window 705 further includes graphical element 725. Based on detection of a triggering input, the device may update the display to reveal information as depicted in display window 730. Display window 730 includes information 735 including text 740 and diagram 745.

As depicted in FIG. 7, diagram data relates to mapping data. It may be appreciated that the diagram data depicted in FIG. 7 relates to display of information based on layers, wherein a graphical display element may be explored. Diagram 745 relates to a map diagram of a state related to the diagram of a continent/country depicted in map diagram 720. Display window 730 further includes graphical element 750 identifying that information may be accessed for information 735.

Based on a second, or additional, triggering input the device may be configured to update the user interface to display window 755. Display window 755 includes graphical representation 760 including text 765, and diagrams 770 and 775. Display window 755 illustrates a relationship between a layer element of display window 730 and its relation to diagram 745. For example, diagram 770 relates to a county of the state depicted in diagram 775, which is also the state depicted in diagram 745. As such, layer information may be presented individually or with additional elements to display a connection between the layers. It should be appreciated that the layered display approach may be provided with three-dimensional images. Further, process 700 may be employed for displaying exploded view diagrams. According to yet another embodiment, information presented based on a triggering input may not be limited to visual data, but may include one or more of audio data, video data, and allow for individual layer selection. As such, the methods and devices described herein may be applied to applications for audio, video, and/or media production.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for presenting information associated with display of at least one of text and diagram data, the method comprising the acts of:
displaying, by a device, a graphical representation of at least one of text and diagram data on a display;
displaying a graphical element, by the device, to provide an indication of information associated with the graphical representation;
detecting a triggering input, by the device, during display of the graphical representation, wherein the triggering input is based on displacement of the device; and
updating the display, by the device, to present information associated with the graphical representation of the at least one of text and diagram data.

2. The method of claim 1, wherein graphical representation of text relates to display of text for one of an electronic reader application and browser.

3. The method of claim 1, wherein graphical representation of diagram data relates to display of one or more of a mapping diagram, a three-dimensional diagram, and a layered diagram.

4. The method of claim 1, wherein the graphical element relates to one or more of a symbol, text, and formatting of text in the display.

5. The method of claim 1, wherein the information includes one or more of text, a formula, a translation of text associated with the graphical representation, an image, video data, audio data, a three-dimensional representation, and a reference position with respect to electronic text.

6. The method of claim 1, wherein the triggered input relates to a gesture based movement of the device.

7. The method of claim 1, wherein updating the display relates to replacing the display of the graphical representation at least one of text and diagram data with display of the information.

8. The method of claim 7, wherein replacing the display of the graphical representation relates to transitioning from the graphical representation to display of the information in one or more of a gradual and stepwise manner.

9. The method of claim 1, wherein updating the display relates to adding a display of one or more graphical elements associated with the information while displaying the graphical representation.

10. The method of claim 1, wherein updating the display relates to displaying a translation of text associated with the graphical representation.

11. The method of claim 1, further comprising detecting a second triggering input, and updating the display of the device to present additional information.

12. The method of claim 11, wherein the additional information is presented by displaying the information as an additional layer to graphical display elements of the display.

13. A computer program product stored on computer readable medium including computer executable code for presenting information associated with display of at least one of text and diagram data, the computer program product comprising:
computer readable code to display a graphical representation of at least one of text and diagram data on a display;
computer readable code to display a graphical element to provide an indication of information associated with the graphical representation;
computer readable code to detect a triggering input during display of the graphical representation, wherein the triggering input is based on displacement of a device; and
computer readable code to update the display to present information associated with the graphical representation of the at least one of text and diagram data.

14. The computer program product of claim 13, wherein graphical representation of text relates to display of text for one of an electronic reader application and browser.

15. The computer program product of claim 13, wherein graphical representation of diagram data relates to display of one or more of a mapping diagram, three-dimensional diagram, and layered diagram.

16. The computer program product of claim 13, wherein the graphical element relates to one or more of a symbol, text, and formatting of text in the display.

17. The computer program product of claim 13, wherein the information includes one or more of text, a formula, a translation of text associated with the graphical representation, an image, video data, audio data, a three-dimensional representation, and a reference position with respect to electronic text.

18. The computer program product of claim 13, wherein the triggered input relates to a gesture based movement of the device.

19. The computer program product of claim 13, wherein updating the display relates to replacing the display of the graphical representation at least one of text and diagram data with display of the information.

20. The computer program product of claim 19, wherein replacing the display of the graphical representation relates to a transitioning from the graphical representation to display of the information in one or more of a gradual and stepwise manner.

21. The computer program product of claim 13, wherein updating the display relates to adding a display of one or more graphical elements associated with the information while displaying the graphical representation.

22. The computer program product of claim 13, wherein updating the display relates to displaying a translation of text associated with the graphical representation.

23. The computer program product of claim 13, further comprising computer readable code to detect a second triggering input, and updating the display of the device to present additional information.

24. The computer program product of claim 23, wherein the additional information is presented by displaying the information as an additional layer to graphical display elements of the display.

25. A device comprising:
a display; and
a processor coupled to the display, the processor configured to
display a graphical representation of at least one of text and diagram data on a display;
display a graphical element to provide an indication of information associated with the graphical representation;
detect a triggering input during display of the graphical representation, wherein the triggering input is based on displacement of the device; and
update the display to present information associated with the graphical representation of the at least one of text and diagram data.

26. The device of claim 25, wherein the device relates to one or more of an eReader, personal communication device, handheld computing device, and computing device in general.
